(19) United States
(12) Patent Application Publication
(10) Pub. No.: US 2022/0332564 A1
(43) Pub. Date: Oct. 20, 2022

(54) BEVERAGE DISPENSER TILTING APPARATUS AND METHOD

(71) Applicant: KEITH LAUSTER DAVIS, TOOELE, UT (US)

(72) Inventor: KEITH LAUSTER DAVIS, TOOELE, UT (US)

(21) Appl. No.: 17/231,525

(22) Filed: Apr. 15, 2021

(51) Int. Cl. B67D 3/00

(52) U.S. Cl. CPC B67D 3/0051; B67D 3/0083

(57) ABSTRACT

A liquid container tilting device capable of automatically tilting to an optimum tilt angle to optimize the draining of the last 1-6 cups of liquid from the container. As the liquid container drains, the tilting angle increases. The tilting apparatus includes: a base that sits on a stable surface, a lever that is formed as a portion of the base and tilts the liquid container, a basket that holds the liquid container securely to the lever. In other embodiments, the device can be cleaned in a household dishwasher, stored on a shelf, hung vertically on a peg, or disassembled and stored inside a 5 gallon liquid container. The tilter promotes safety, efficiency, and saves time by eliminating the need for a second person to lift, tilt, and empty the last dregs of liquid from the liquid container.

THE NOVELTY FACTOR—This device is designed for home use and group gatherings, anywhere portable, liquid dispensers are used. There is no need for external springs, manually operated jacks, electric motors, or hydraulic devices, to lift or position the tilter or tilt the liquid containers.

ADVANTAGE—Enables one person to dispense the last dregs of liquid i.e. water, lemonade, or chemicals from the liquid container safely and automatically.

### BACKGROUND

### The Field of the Invention

This invention relates to liquid containment, dispensing, and more particularly, to novel systems and methods of draining the last dregs of liquid from the container.

### Background Art

Portable liquid containers allow for the economical refreshment of guests in areas that were not built with expensive, inflexible liquid drink dispensers. These portable liquid dispensers allow for a large variety of both cold and hot beverages to be served, and increase capacity and flexibility for change in liquid need.

Spouts and Spigots are used to control the flow of the liquid out of the liquid dispenser. Depending on the size of the spout or spigot determines the placement location on or in the liquid dispenser. The majority of spouts and spigots are placed within 1½ inches of the bottom of the container. When sitting level on a table approximately 6 cups of liquid remain in a 5-gallon container sit below the drain opening for the spout or spigot.

Currently, for one person to drain the last dregs of the liquid from the contain, the container must be lifted up and tilted with one hand while the other hand is holding a receptacle under the spout or spigot and activating the spout or spigot. To safely drain the last dregs from the container it takes two people. One person to hold and tilt the container and the other to activate the spigot or spout and hold the receptacle.

The liquid dispenser tilting apparatus tilts the liquid container automatically thereby eliminating the need for a second person and the inherent risk of dropping the container while lifting and tilting it.

### SUMMARY OF THE INVENTION

In view of the foregoing, in accordance with the invention as embodied and broadly described herein, the apparatus uses the laws of physics and stores potential energy in the folded lever that forms the platform lever and base, to tilt the liquid dispenser up on one side, gravity pulls the liquid inside the dispenser to a level puddle and pool above the spout and spigot drain hole within the liquid dispenser.

The combined weight of the dispenser and the liquid stored inside is sufficient to overcome the potential energy stored in the folded lever and base. The dispenser sits flat on the platform lever and base. As the dispenser is drained, the weight sitting on the lever decreases. At a point in time, as the contained liquid is drained, the potential stored energy is sufficient to start lifting the lever and tilting the liquid dispenser up and forward. The flow of the liquid out of the spout Or spigot remains constant until the container is empty as defined as less than 1 cup of liquid.

The maximum (optimum) angle of the lever platform and the dispenser is controlled by the lever range guide and the platform lever stop. The movement of the platform lever is gradual from the level position to an optimum angel of tilting for draining the liquid dispenser. The liquid dispenser is secured in a basket attached to the platform lever. In the case of a 5-gallon liquid container, all but 5-7 ounces of liquid can be drained from the liquid dispenser.

### BRIEF DESCRIPTIONS OF THE DRAWINGS

FIG. 1 is a side view of one embodiment of a system including the base, guard rail, lever range stop, platform lever, side stops, front stops, anti-skid buttons on the bottom of the base to keep the apparatus from moving while in use. The lever platform is represented as if it was in the full down or level position.

FIG. 2 is a side view of one embodiment of a system including the base, guard rail, lever range stop, platform lever, side stops, front stops, anti-skid buttons on the bottom of the base to keep the apparatus from moving while in use. The lever platform is represented as if it was in the full up position.

FIG. 3 is a side view of one embodiment of a system including the base, guard rail, lever range stop, platform lever, side stops, front stops, anti-skid buttons on the bottom of the base to keep the apparatus from moving while in use. The lever platform is represented as if it was in the full down or level position. The liquid container with spout or spigot is represented in the level or static position with the dregs of the liquid below the spout or spigot drain hole.

FIG. 4 is a side view of one embodiment of a system including the base, guard rail, lever range stop, platform lever, side stops, front stops, anti-skid buttons on the bottom of the base to keep the apparatus from moving while in use. The lever platform is represented as if it was in the full up position. The liquid container with spout or spigot is represented in the tilted position with the dregs of the liquid pooling above the spout or spigot drain hole.

FIG. 5 is a flat plate view of the apparatus before it is folded. Focusing on the top half of the apparatus, it includes the platform lever, side stops, front stops, and platform lever stops.

FIG. 6 is a flat plate view of the apparatus before it is folded. Focusing on the bottom half of the apparatus, it includes the base, the anti-skid buttons, and the utility tab & nail storage hole.

FIG. 7, represents the tilting apparatus stored in a 5-gallon liquid dispensing jug. The liquid dispenser tilting apparatus includes the base, the lever range guide, travel limit opening, platform lever, side arms, front fence, anti-skid buttons, liquid dispenser, spigot/spout drain opening, nut and washer on the platform lever stop bolt, acute angle fold, positioning pegs, basket, supporting surface, liquid dispenser lid. The platform is represented in the full down position.

FIG. 8 represents the liquid dispenser tilting apparatus including the base, the lever range guide, travel limit opening, platform lever, side arms, front fence, anti-skid button, nut and washer on the platform lever stop bolt, storage hang hole w/nail, acute angle fold, vertical supporting surface (post or wall). The platform, is represented in the full down position.

FIG. 9, represents the liquid dispenser tilting apparatus's separate parts in a household dishwasher.

FIG. 10, is a top down view of the basket used for securing liquid dispensers with a cylindrical base, identifying the basket base, fences, arms, alignment pegs, support structure, and opening use to attach the liquid dispenser tilting apparatus lever platform and base.

FIG. 11, is a top down view of the basket used for liquid dispensers with a square or rectangular base, identifying the basket base, fences, arms, alignment pegs, support structure, and opening used to attach the liquid dispenser tilting apparatus lever platform and base.

FIG. 12, A schematic block diagram of a method, whereby one embodiment of the system may be implemented and maintained.

### DETAILED DESCRIPTION OF THE PREFERRED EMBODIMENTS

It will be readily understood that the components of the present invention, as generally described and illustrated in the drawings herein, could be arranged and redesigned in a wide variety of different configurations. Thus, the following more detailed description of the embodiments of the system and method of the present invention, as represented in the drawings, is not intended to limit the scope of the invention, but is merely representative of apparatus and methods in accordance with the invention. The illustrated embodiments will be best understood by reference to the drawings, wherein like parts are designated by like numerals throughout.

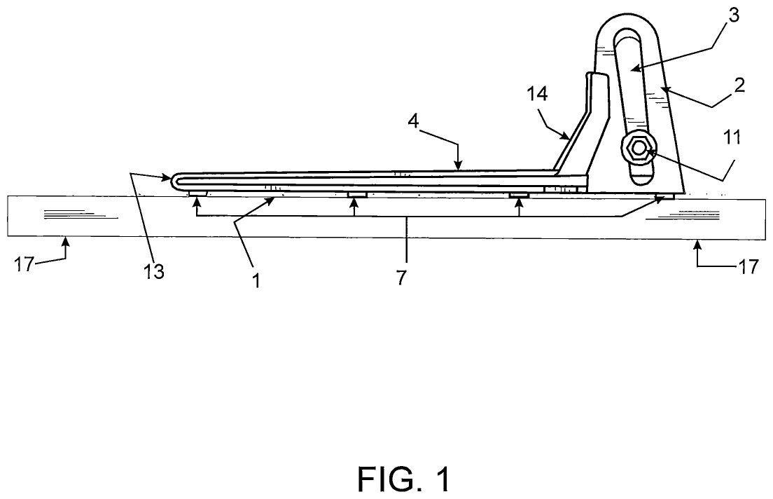

Referring to FIG. 1, the tilting apparatus includes a base 1, platform lever range guide 2 with travel limit opening 3, platform lever 4, side stabilizers 14, anti-skid buttons 7, acute angle fold 13, and the nut and washer on the platform lever stop bolt 11. The platform lever is represented as if it is in the full down or level position.

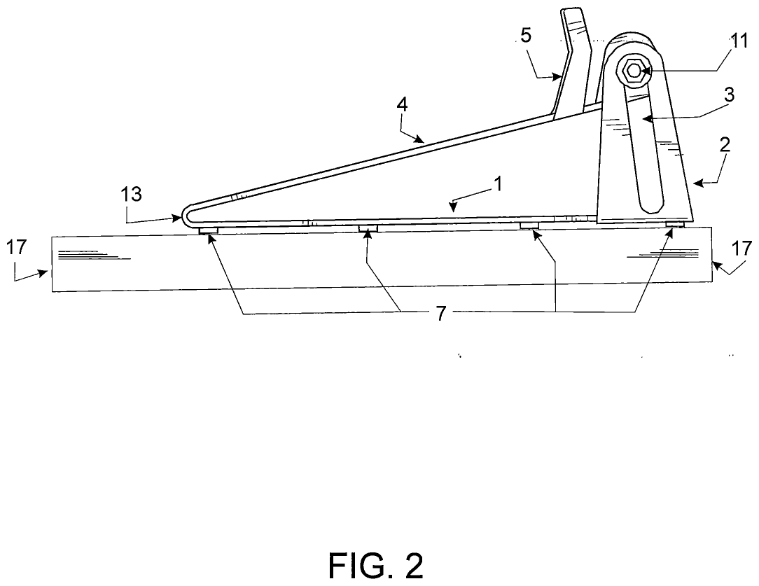

Referring to FIG. 2, the tilting apparatus includes a base 1, platform lever range guide 2 with travel limit opening 3, platform lever 4, side stabilizers 14, anti-skid buttons 7, acute angle fold 13, and the nut and washer on the platform lever stop bolt 11. The platform lever is represented as if it is in the full up or tilting position.

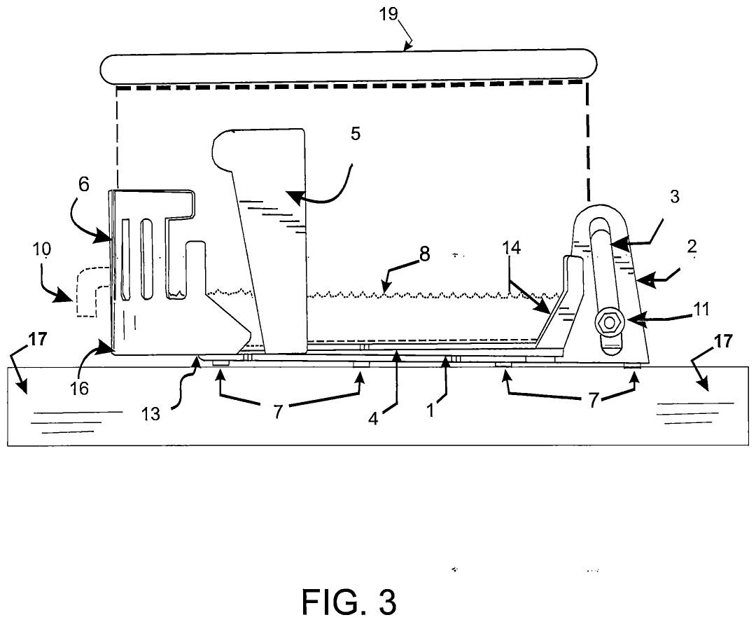

Referring to FIG. 3, the beverage dispenser tilting apparatus includes the base 1, lever range stop 2 with travel limit opening 3, platform lever 4, side stabilizers 14, anti-skid buttons 7, acute angle fold 13, and the nut and washer on the platform lever stop bolt 11. It includes the basket with side arms 5 and front fence 6, including the representation of a beverage dispenser 9, with the top level of the liquid 8, depicted at or above the bottom of the spigot/spout and interior drain opening 10. The platform lever is represented as if it is in the full down or level position.

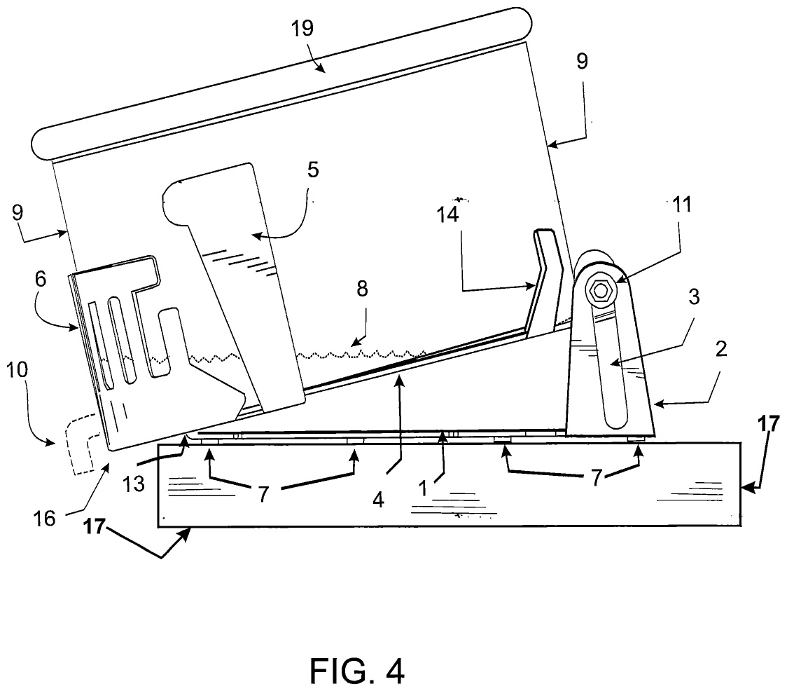

Referring to FIG. 4, the beverage dispenser tilting apparatus includes the base 1, lever range stop 2 with travel limit opening 3; platform lever 4; side stabilizers 14, anti-skid buttons 7, acute angle fold 13, and the nut and washer on the platform lever stop bolt 11. It includes the basket with side arms 5 and front fence 6, including the representation of a beverage dispenser 9, with the top level of the liquid 8, depicted at or above the bottom of the spigot/spout and interior drain opening 10. The platform lever is represented as if it is in the full up or tilting position:

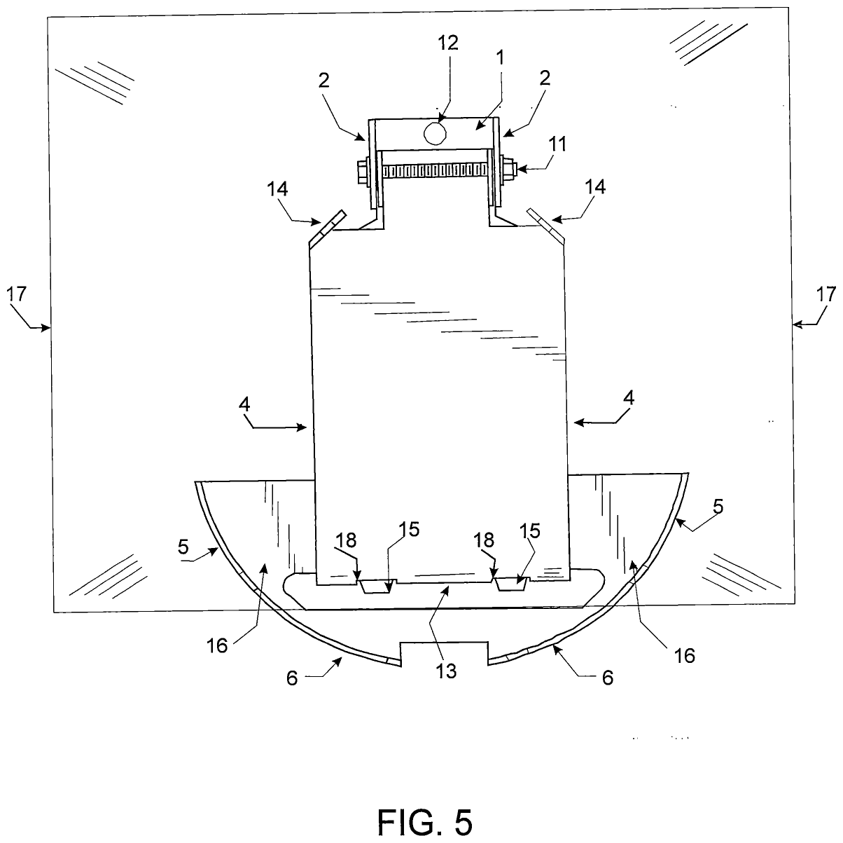

Referring to FIG. 5, a top-down elevation view including the base 1, platform lever 4, lever range stop 2, side stabilizers 14, acute angle fold 13, positioning pegs 15, nut and washer on the platform lever stop bolt 11, basket 16 with side arms 5, front fence 6.

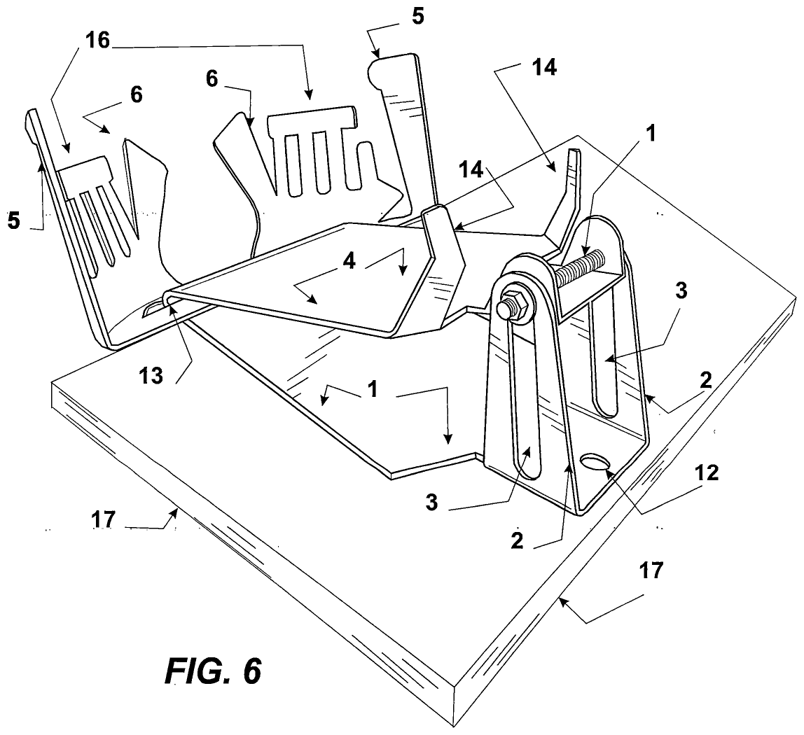

Referring to FIG. 6, a rear-side elevation view including the base 1, platform lever 4, lever range stop 2 with travel limit opening 3, rear and side stabilizers 14, acute angle fold 13, hang hole 12, nut, bolt, and washer lever stop bolt 11, basket 16 with side arms 5, and front fence 6.

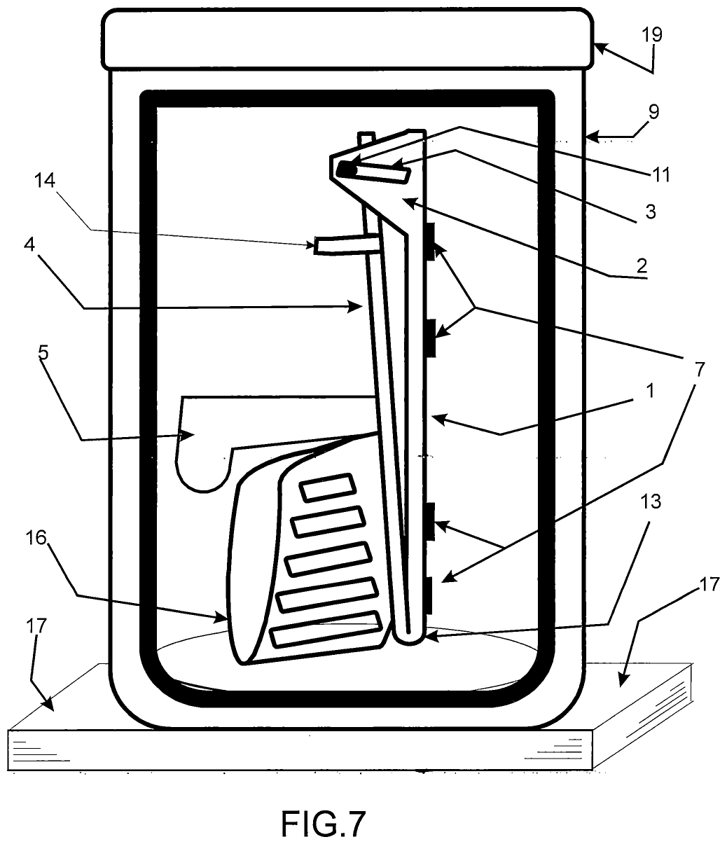

Referring to FIG. 7, represents the tilting apparatus stored in a 5-gallon liquid dispensing jug 9. The liquid dispenser tilting apparatus includes the base 1, the platform lever range guide 2, travel limit opening 3, platform lever 4, side arms 5, front fence 16, anti-skid buttons 7, liquid dispenser 9, nut and washer on so the platform lever stop bolt 11, acute angle fold 13, supporting surface 17, liquid dispenser lid 19. The platform is represented in the full down position.

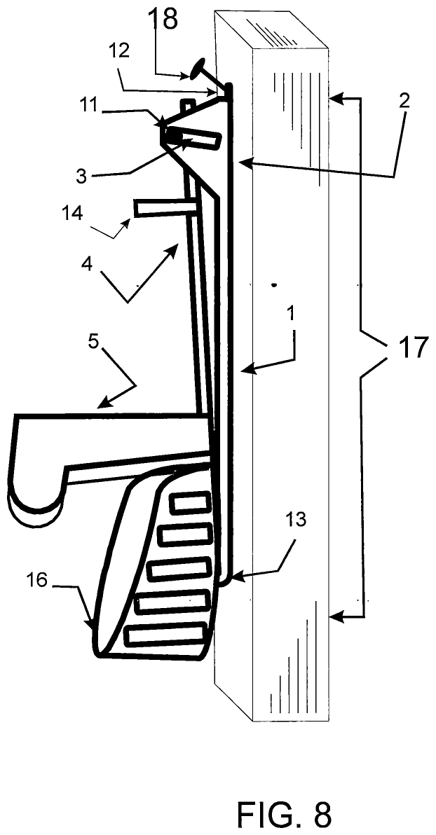

FIG. 8 represents the liquid dispenser tilting apparatus including the base 1, the platform lever range guide 2, travel limit opening 3, platform lever 4, side arms 5, front fence 16, nut and washer on the platform lever stop bolt 11, storage hang hole 12, w/nail 18, acute angle fold 13, vertical supporting surface (post or wall) 17. The platform is represented in the full down position.

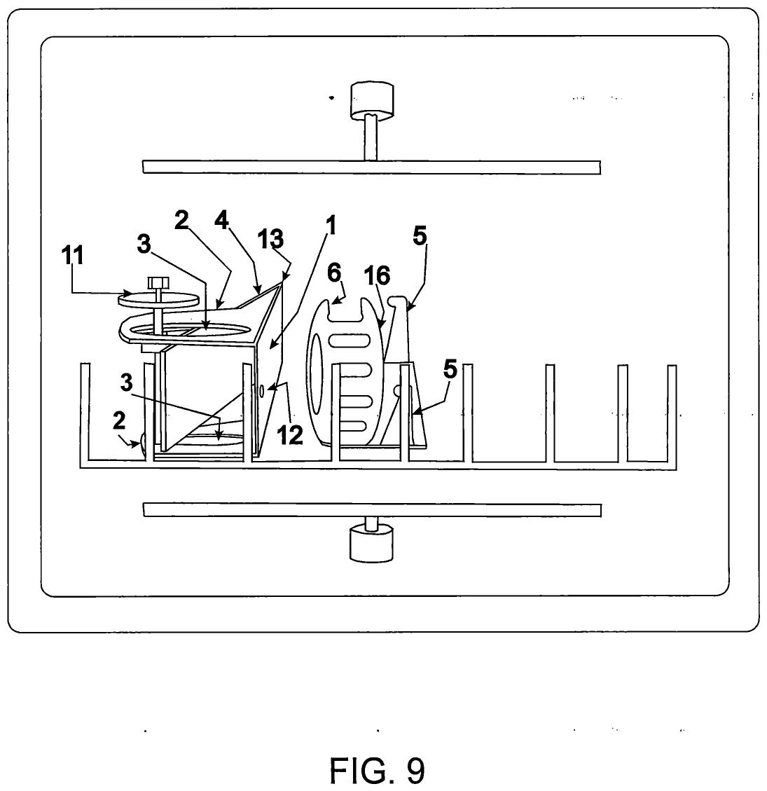

FIG. 9, represents the liquid dispenser tilting apparatus's separate parts in a household dishwasher. The base 1, the platform lever range guide 2, travel limit opening 3, platform lever 4, side arms 5, basket 6, front fence 16, nut and washer on the platform lever stop bolt 11, acute angle fold 13.

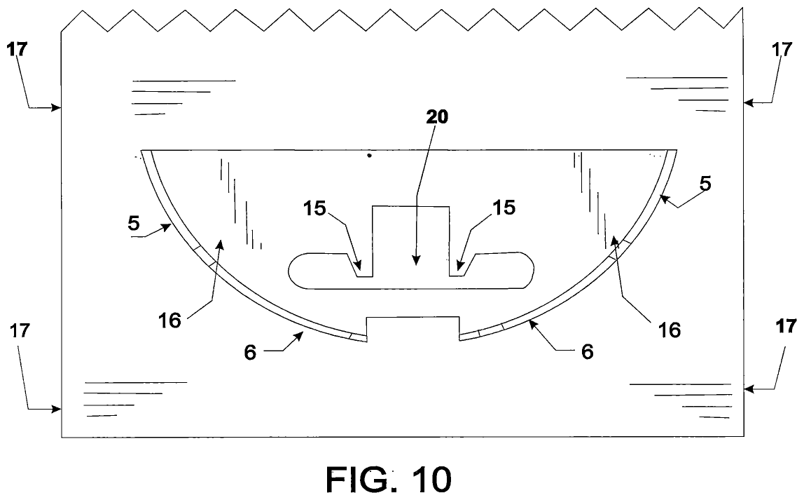

FIG. 10, is a top down view of the basket used for cylindrical liquid dispensers, identifying the basket base 16, fences 6, arms 5, alignment pegs 15, support structure 17, and opening 20 use to attach the liquid dispenser tilting apparatus platform lever and base.

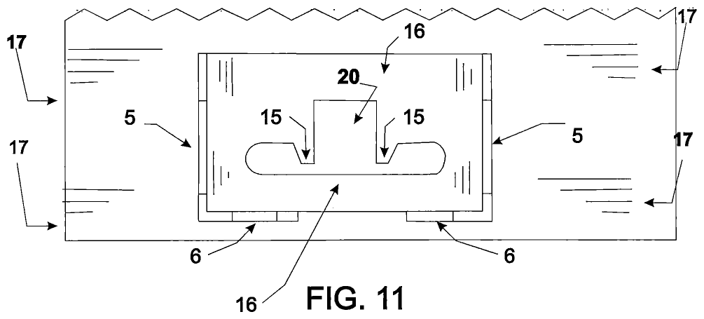

FIG. 11, is a top down view of the basket used for liquid dispensers with a square or rectangular base, identifying the basket base 16, fences 6, arms 5, alignment pegs 15, support structure 17, and opening 20 used to attach the liquid dispenser tilting apparatus platform lever and base.

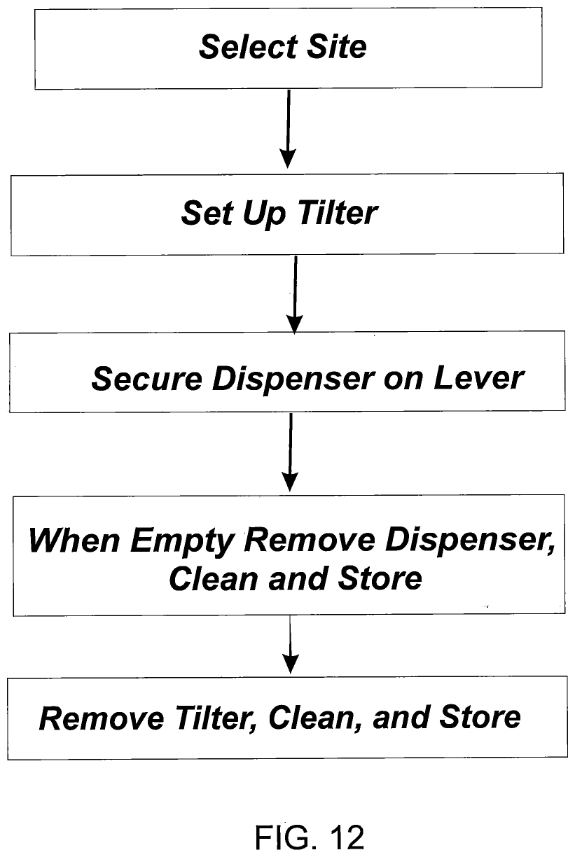

FIG. 12, A schematic block diagram of a method, whereby one embodiment of the system may be implemented and maintained.

What is claimed and desired to be secured by United States Letters Patent is:

1. An apparatus known as The Liquid Container Tilting Apparatus, which consists of three primary parts:
a base, fitted to rest on a supporting surface with anti-skid buttons effective in protecting the supporting surface and keeping the base from moving on the supporting surface;
a platform lever, comprised of a portion of the base, rectangular in shape, folded laterally at a point forming an acute angle that defines the base and the platform lever such that the base, when the apparatus is used, is stationary on a supporting surface, tabletop or countertop;
a basket, to secure the liquid container to the platform lever; the basket comprised of a bottom which has a slot opening that allows the basket to be attached or removed from the platform lever; side arms, front fence, positioning pegs, and rear stabilizing guides; the positioning pegs are used to align the basket with the slots in the platform lever, allowing the basket to be secured to the platform lever; rear stabilizing guides define the position of the liquid container on the platform lever and provide stability to the container as it is tilted; when the apparatus is used, the platform lever is compressed by the weight of the liquid dispenser and its contents creating kinetic energy which is stored in both the base and the platform lever for lifting and tilting the liquid dispenser from a nearly flat or level position aligned in relation with the base and touching the base when the liquid dispenser is full of liquid; platform lever travel guides and travel limiting spaces are formed into both the base and the platform lever; a platform lever stop bolt/key/pin, keeps the platform lever from tilting beyond an optimum drain angle as the liquid is drained from the dispenser out the spigot/spout/drain; as the total weight of the liquid dispenser on the platform lever decreases, the platform lever and liquid dispenser gradually tilt up such that the level of the remaining liquid, inside the dispenser, stays above the bottom of the spigot/spout/drain line, allowing the maximum amount of liquid to empty from the dispenser; at the end of the event in which the liquid dispenser and tilting apparatus were used, the tilting apparatus can be disassembled and cleaned in a household dishwasher; in other embodiments, the tilting apparatus is designed to be taken apart and stored inside a 5 gallon liquid dispenser, hung on a nail for storage using the nail hole at the top of the base when held vertically; or stored flat on a shelf.
